(19) United States
(12) Patent Application Publication
(10) Pub. No.: US 2025/0264055 A1
(43) Pub. Date: Aug. 21, 2025

(54) CYCLONIC SEPARATOR FOR GAS TURBINE ENGINE

(71) Applicant: General Electric Company, Schenectady, NY (US)

(72) Inventors: Ajay Kumar Verma, Bengaluru (IN); Raju Sanjay, Bengaluru (IN); Veera Venkata Amarnath Manem, Bengaluru (IN)

(21) Appl. No.: 19/042,136

(22) Filed: Jan. 31, 2025

(30) Foreign Application Priority Data
Feb. 21, 2024 (IN) 202411012304

(51) Int. Cl. F02C 7/057; F02C 7/18

(52) U.S. Cl. CPC F02C 7/057; F02C 7/18; F05D 2260/232

(57) ABSTRACT

A cyclonic separator for a turbine cooling airflow of a gas turbine engine includes a housing, a central body, an inlet, a first fluid outlet, a second fluid outlet, and a fluid deflector. The housing includes a first end, a second end, and an outer wall extending between the first end and the second end. The central body is disposed in the housing and defines an annular chamber with the outer wall. The inlet is disposed at the first end and is in fluid communication with the annular chamber. The first fluid outlet is disposed at the second end. The second fluid outlet is disposed in the outer wall downstream of the first end and extends outward at least partially in the radial direction. The fluid deflector is disposed on the central body and extends outward in the radial direction and rearward in the axial direction.

### PRIORITY INFORMATION

The present application claims priority to Indian patent application Ser. No. 20/241,1012304 filed on Feb. 21, 2024.

### FIELD

The present disclosure relates to a gas turbine engine, and more particularly to a cyclonic separator for a gas turbine engine.

### BACKGROUND

Turbine engines, and particularly gas or combustion turbine engines, are rotary engines that extract energy from a flow of combusted gases passing through the engine onto a multitude of turbine blades. Gas turbine engines have been used for land and nautical locomotion and power generation, but are most commonly used for aeronautical applications such as for aircraft. In aircraft, gas turbine engines are used for propulsion of the aircraft. In terrestrial applications, turbine engines are often used for power generation.

Gas turbine engines for aircraft are designed to operate at high temperatures to maximize engine efficiency, so cooling of certain engine components, such as the high pressure turbine and the low pressure turbine, can be necessary. Typically, cooling is accomplished by ducting cooler air from the high and/or low pressure compressors to the engine components that require cooling. While the compressor air is provided at a high temperature, it is cooler relative to the turbine air, and can be used to cool the turbine. When cooling the turbines, cooling air can be supplied to various turbine components, including the interior of the turbine blades and the turbine shroud.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of an exemplary gas turbine engine.

FIG. 2 is a cross-sectional view of a cooling circuit of the gas turbine engine of FIG. 1.

FIG. 3 is a cross-sectional view of a cyclonic separator of the cooling circuit with a fluid deflector.

FIGS. 4A-4C are cross-sectional views of arrangements of the fluid deflector in the cyclonic separator.

FIG. 5 is a cross-sectional view of another cyclonic separator of the cooling circuit with a fluid deflector having a conical shape.

FIG. 6 is a cross-sectional view of another cyclonic separator of the cooling circuit with a central body having an internal channel.

FIG. 7 is a cross-sectional view of another cyclonic separator of the cooling circuit with a fluid deflector with a counterclockwise chirality.

FIGS. 8A-8C are cross-sectional views of arrangements of the fluid deflector in the cyclonic separator of FIG. 7.

FIGS. 9A-9B are cross-sectional views of fluid deflectors in the cyclonic separator of FIG. 7 with varying thread pitch.

FIG. 10 is a cross-sectional view of another fluid deflector in the cyclonic separator of FIG. 7 with a clockwise chirality.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The terms “forward” and “aft” refer to relative positions within a gas turbine engine, with “forward” referring to a position closer to an engine inlet and “aft” referring to a position closer to an engine nozzle or exhaust.

The terms “upstream” and “downstream” refer to the relative direction with respect to fluid flow in a fluid pathway. For example, “upstream” refers to the direction from which fluid flows, and “downstream” refers to the direction to which the fluid flows.

The present disclosure is generally related to removal of particulate matter from air flows in a gas turbine engine. Air flowing through the engine for cooling various components of the gas turbine engine may accumulate particulate matter. The particulate matter, such as dirt, dust, sand, ash, and other environmental contaminants, in the cooling air can cause a loss of cooling and reduced operational time for the aircraft environment. Particles supplied to the turbine components can clog, obstruct, or coat the flow passages and surfaces of the components, which can reduce the lifespan of the components.

To reduce the amount of particulate matter in the cooling air flows, a cyclonic separator swirls air in cyclic motion, applying centrifugal force on the particulate matter. The centrifugal forces push the particulate matter to a radial edge of the cyclonic separator, and a particle separator inhibits movement of the particulate matter back into the swirled air flow. An exit flow removes the particulate matter from the cyclonic separator, and the swirled air flow exits the cyclonic separator to cool the components of the gas turbine engine.

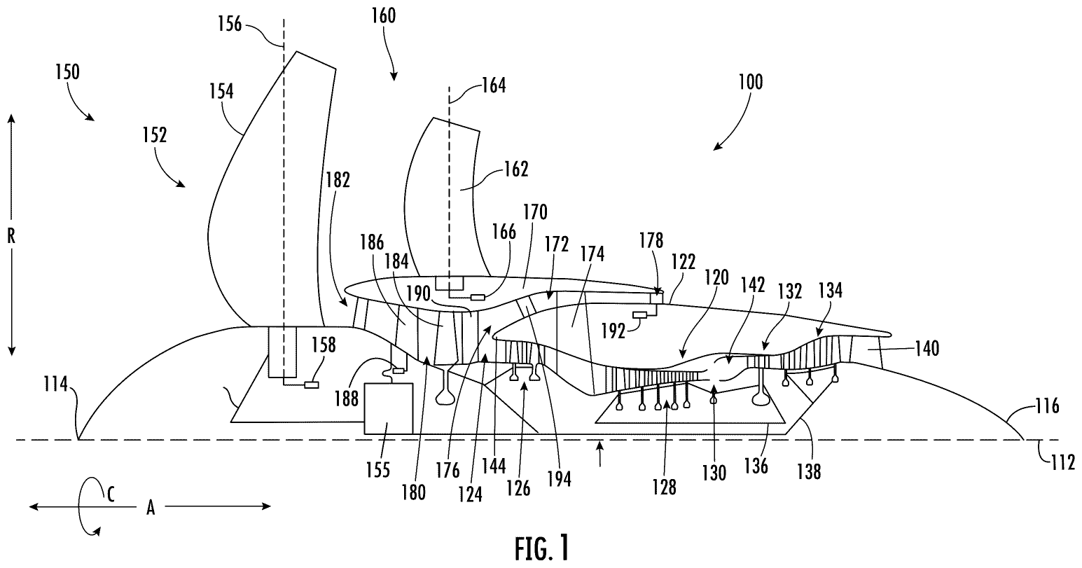

Referring now to FIG. 1, a schematic cross-sectional view of a gas turbine engine 100 is provided according to an example embodiment of the present disclosure. Particularly, FIG. 1 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the engine 100 of FIG. 1 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor (referred to as an LP compressor 126 herein) for pressurizing the air that enters the turbomachine 120 through core inlet 124. A high pressure (“HP”), multi-stage, axial-flow compressor (referred to as an HP compressor 128 herein) receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to an HP turbine 132. The HP turbine 132 drives the HP compressor 128 through an HP shaft 136. In this regard, the HP turbine 132 is drivingly coupled with the HP compressor 128. The high energy combustion products then flow to an LP turbine 134. The LP turbine 134 drives the LP compressor 126 and components of the fan section 150 through an LP shaft 138. In this regard, the LP turbine 134 is drivingly coupled with the LP compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the LP turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to the fan cowl 170.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the LP turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between the engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

Notably, for the embodiment depicted, the engine 100 includes one or more features to increase an efficiency of a third stream thrust (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust during one or more engine operating conditions. Further, by introducing a variability in the geometry of the inlet guide vanes 186 and the fan exhaust nozzle 178, the engine 100 may be capable of generating more efficient third stream thrust across a relatively wide array of engine operating conditions, including takeoff and climb (where a maximum total engine thrust is generally needed) as well as cruise (where a lesser amount of total engine thrust is generally needed).

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 194 may be positioned in thermal communication with the fan duct 172. For example, one or more heat exchangers 194 may be disposed within the fan duct 172 and utilized to cool one or more fluids from the core engine with the air passing through the fan duct 172, as a resource for removing heat from a fluid, e.g., compressor bleed air, oil or fuel.

Although not depicted, the heat exchanger 194 may be an annular heat exchanger extending substantially 360 degrees in the fan duct 172 (e.g., at least 300 degrees, such as at least 330 degrees). In such a manner, the heat exchanger 194 may effectively utilize the air passing through the fan duct 172 to cool one or more systems of the engine 100 (e.g., lubrication oil systems, compressor bleed air, electrical components, etc.). The heat exchanger 194 uses the air passing through the fan duct 172 as a heat sink and correspondingly increases the temperature of the air downstream of the heat exchanger 194 and exiting the fan exhaust nozzle 178.

It will be appreciated, however, that the exemplary gas turbine engine 100 is provided by way of example only. In other exemplary embodiments, the gas turbine engine 100 may have any other configuration. For example, in other exemplary embodiments, the turbomachine 120 may have any other number and arrangement of shafts, spools, compressors, turbines, etc. Further, in other exemplary embodiments, the gas turbine engine 100 may alternatively be configured as a ducted turbofan engine (including an outer nacelle surrounding the fan 152 and a portion of the turbomachine 120); as a direct drive gas turbine engine (may not include a reduction gearbox, such as the speed reduction gearbox 155); as a fixed pitch gas turbine engine (may not include a variable pitch fan, such as fan 152); as a two-stream gas turbine engine (may not include the fan duct 172); etc.

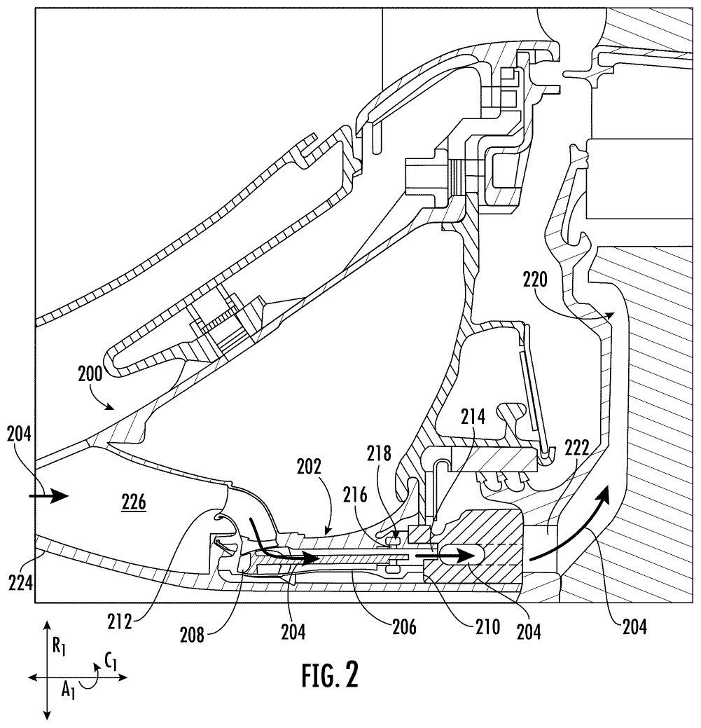

Now referring to FIG. 2, the gas turbine engine 100 includes a cooling circuit 200. The cooling circuit 200 is disposed between the compressor section and the turbine section to provide cooling air from the compressor section to the turbine section. More specifically, the cooling air flows from the HP compressor 128, bypassing the combustor 130, through the cooling circuit 200. The cooling air then flows to the HP turbine 132. In such a manner, it will be appreciated that the phrase “between the compressor section and the turbine section” may refer to being downstream of at least a portion of the compressor section (e.g., receiving an airflow from a portion of the compressor section) and upstream of at least a portion of the turbine section (e.g., providing an airflow to at least a portion of the turbine section).

The cooling circuit 200 includes a cyclonic separator 202 to remove impurities from cooling air 204, such as dust or debris. The cyclonic separator 202 defines a radial direction R1, an axial direction A1, and a circumferential direction C1. It will be appreciated that the directions R1, A1, C1 of the cyclonic separator 202 are locally defined with respect to the cyclonic separator 202. However, in the embodiment shown, the axial direction Al is arranged parallel to the axial direction A of the gas turbine engine 100 (FIG. 1).

The cyclonic separator 202 includes a housing 206 extending from a first end 208 to a second end 210, a fluid inlet 212 disposed at the first end 208 of the housing 206, a first fluid outlet 214 disposed at the second end 210 of the housing 206, and a second fluid outlet 216. The fluid inlet 212 receives air from the compressor section, and the first fluid outlet 214 transmits air to the turbine section. The second fluid outlet 216 transmits air containing impurities to an exit flow 218, which is directed away from the combustion section and turbine section. The cooling circuit 200 provides air suitable for cooling one or more components of the gas turbine engine 100, such as the HP turbine 132 and the LP turbine 134.

More specifically, the HP turbine 132 defines a cooling passage 220 and includes an inducer 222 configured to introduce a circumferential swirl to the cooling air 204 provided by the cooling circuit 200 to the cooling passage 220 of the HP turbine 132. In particular, the cooling circuit 200 may receive the cooling air 204 from the compressor section, such as from an exit of the compressor section. The gas turbine engine 100 includes, at the combustion section, an inner airflow passage 224 located inward of the combustor 130 along the radial direction R of the gas turbine engine 100, and a chamber 226. The cooling air 204 is, in the embodiment shown, provided through the inner airflow passage 224 and into the chamber 226. The cooling air 204 in the chamber 226 is provided to the cooling circuit 200 of the present disclosure, where particles within the cooling air 204 are separated out, as described herein. The cleaned cooling air 204 is provided through the inducer 222 and into the cooling passage 220 of the HP turbine 132 to cool the HP turbine 132.

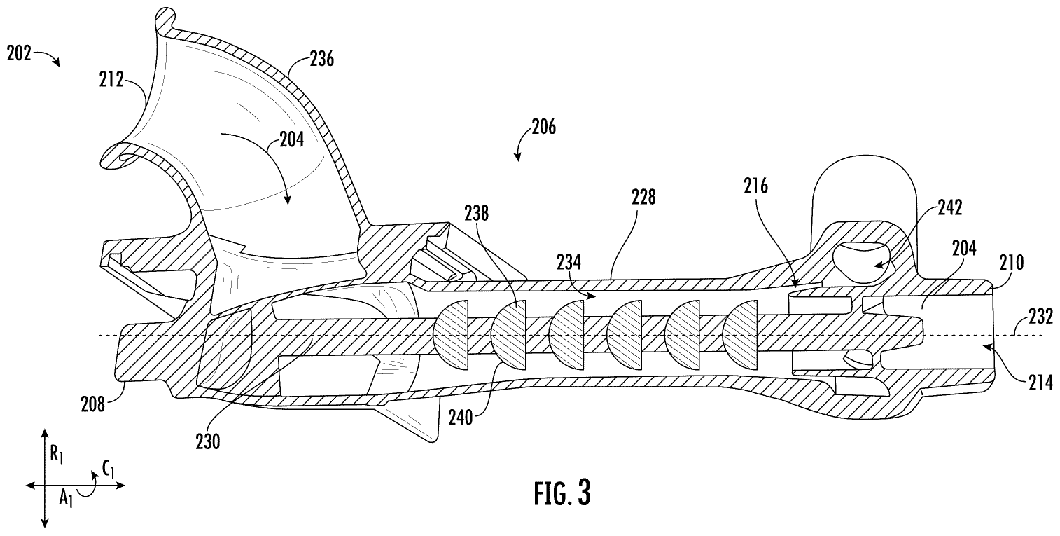

With reference to FIG. 3, a cross-sectional schematic view of the cyclonic separator 202 of the cooling circuit is provided. The exemplary cyclonic separator 202 of FIG. 3 may be incorporated into the cooling circuit 200 described above with reference to FIG. 2.

As described above, the cyclonic separator 202 includes the housing 206 extending from the first end 208 to the second end 210, the fluid inlet 212 disposed at the first end 208 of the housing 206, the first fluid outlet 214 disposed at the second end 210 of the housing 206, and the second fluid outlet 216. The housing 206 includes an outer wall 228 that extends between the first end 208 and the second end 210 and a central body 230 disposed along a centerline 232. The housing 206 defines an annular chamber 234 between the outer wall 228 and the central body 230. The annular chamber 234 may define a circular cross-sectional shape. Alternatively, the annular chamber 234 define an oblong shape, or other suitable cross-sectional shape capable of achieving the benefits disclosed herein.

The fluid inlet 212 includes a bend 236 that is arranged to swirl the cooling air 204 through the annular chamber 234 around the central body 230. As the cooling air 204 flows from the chamber 226, the bend 236 directs the cooling air 204 into circular motion. The cooling air 204 then swirls into the annular chamber 234 along the central body 230.

The cyclonic separator 202 includes one or more fluid deflectors 238 disposed on the central body 230. The fluid deflectors 238 direct the cooling air 204 toward the outer wall 228 and the second fluid outlet 216, causing particles in the cooling air 204 to accumulate along the outer wall 228 by centrifugal forces. More specifically, the fluid deflectors 238 are disposed on the central body 230 between the first end 208 of the housing 206 and the second end 210 of the housing 206 to direct the cooling air 204 swirled by the fluid inlet 212 in the axial direction A1 outward in the radial direction R1 toward the second fluid outlet 216, removing particles from the cooling air 204. The exemplary cyclonic separator 202 of FIG. 3 shows six fluid deflectors 238, and the cyclonic separator 202 may have a different number of fluid deflectors 238, such as three, eight, or any other suitable number.

To provide direction to the cooling air 204, the fluid deflectors 238 each extend outward in the radial direction R1 and rearward in the axial direction A1 into the annular chamber 234 toward the outer wall 228. Specifically, the fluid deflectors 238 each include an upstream surface 240 that extends outward in the radial direction R1 and rearward in the axial direction A1. As the cooling air 204 reaches one of the fluid deflectors 238, the fluid deflector 238 provides a flow path for the cooling air 204 toward the outer wall 228. In the exemplary embodiment of FIG. 3, the upstream surface 240 of each fluid deflector 238 has a hemispherical shape. The hemispherical shape provides a curved surface on which the cooling air 204 swirls to push the particulates toward the outer wall 228. It will be appreciated that the upstream surface 240 may have a different convex shape, such as a parabola or a wave.

The first fluid outlet 214 directs the cooling air 204 flowing through the annular chamber 234 out from the second end 210 of the housing 206 to the turbine section. As the cooling air 204 swirls through the annular chamber 234, a portion of the cooling air 204 from which particulates were removed flows in the axial direction A1 toward the first fluid outlet 214. The cooling air 204 flows out through the first fluid outlet and into the inducer 222.

The second fluid outlet 216 removes particulates from the cooling air 204. When the cooling air 204 is deflected by the fluid deflectors 238, heavier particulates accumulate along the outer wall 228. The second fluid outlet 216 is disposed in the outer wall 228 downstream of the first end 208 of the housing 206 to receive the cooling air 204 with the particulates. The second fluid outlet 216 extends outward at least partially in the radial direction RI relative to the outer wall 228, defining an outlet passage 242 in fluid communication with the exit flow 218 shown in FIG. 2.

The particulates move in the axial direction Al along the outer wall 228 through the outlet passage 242 to the exit flow 218. The second fluid outlet 216 thus removes the particulates from the cyclonic separator 202, reducing the amount of particulates in the remaining cooling air 204 that flows to the first fluid outlet 214.

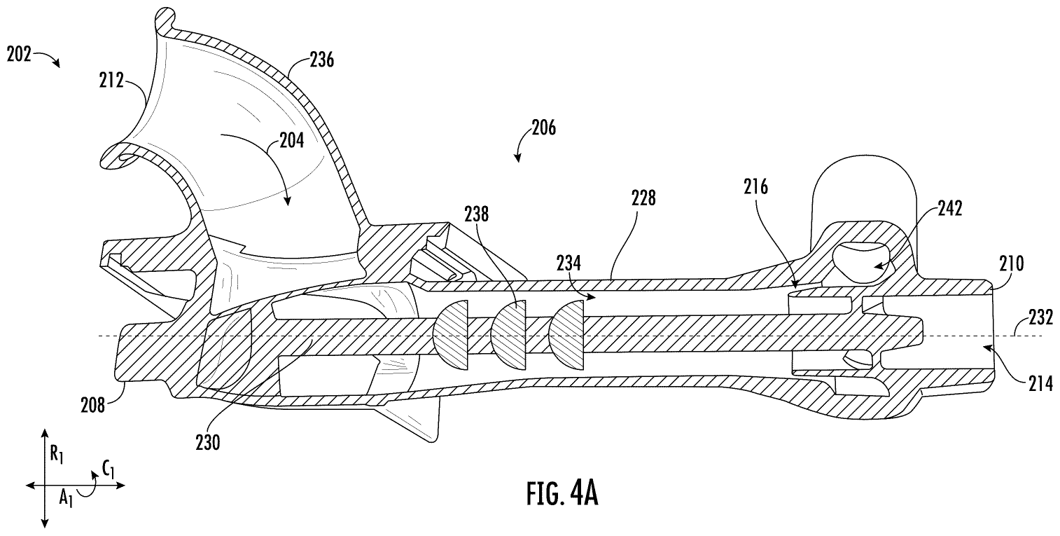

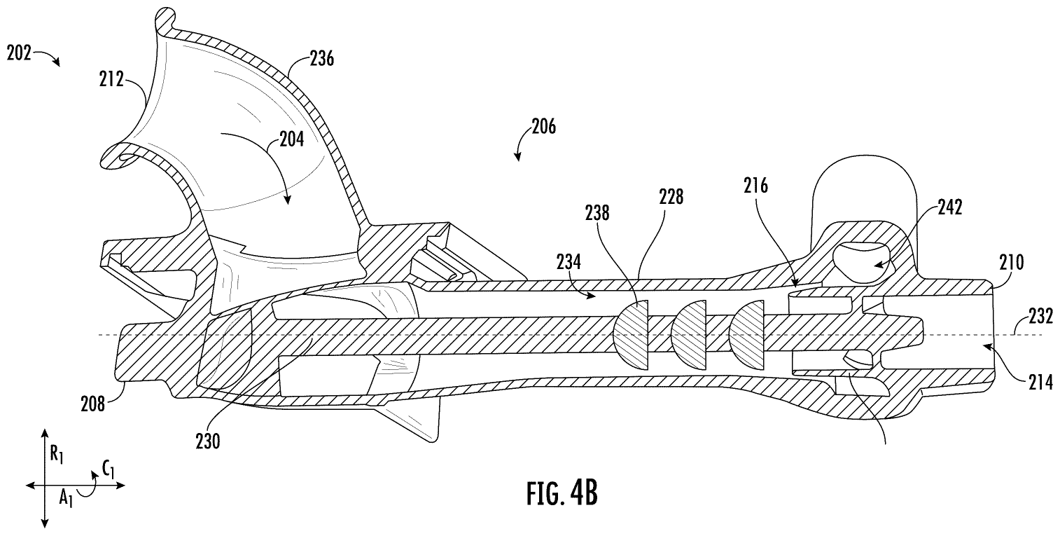

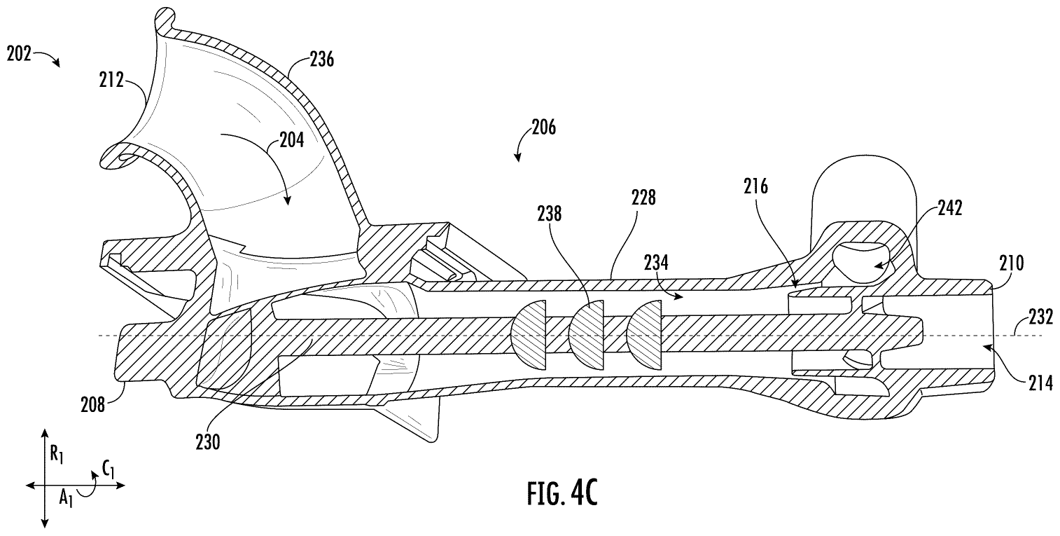

As shown in FIGS. 4A-4C, cross-sectional schematic views of exemplary fluid deflectors 238 are provided. FIG. 4A shows the fluid deflectors 238 arranged at a first axial position proximate to the fluid inlet 212. FIG. 4B shows the fluid deflectors 238 arranged at a second axial position proximate to the first fluid outlet 214. FIG. 4C shows the fluid deflectors 238 at a third axial position substantially halfway between the fluid inlet 212 and the first fluid outlet 214. In this context, the fluid deflectors 238 are “proximate” to the fluid inlet 212 or the first fluid outlet 214 when they are closer the specified one of the fluid inlet 212 or the first fluid outlet 214 than the other of the fluid inlet 212 or the first fluid outlet.

The fluid deflectors 238 are positioned on the central body 230 at specified axial positions in the axial direction A1 to control where the particulates in the cooling air 204 are directed toward the outer wall 228. As an example, the arrangement of FIG. 4A removes the particulates soon after the cooling air 204 flows through the fluid inlet 212, allowing the remaining cooling air 204 to swirl along the central body 230 unencumbered.

The arrangement of FIG. 4B removes the particulates close to the second fluid outlet 216, which may inhibit the particulates from flowing back into the cooling air 204. The axial position of the fluid deflector of FIG. 4B may improve separation of the particulates from the cooling air 204 immediately before the cooling air 204 leaves the cyclonic separator 202.

The arrangement of FIG. 4C balances the benefits of fluid deflection near the fluid inlet 212 and near the first fluid outlet 214. That is, when the axial position of the fluid deflector 238 is near the middle of the central body 230, the swirled cooling air 204 may move to the first fluid outlet 214 unencumbered, and the particulates may not have sufficient time to return to the cooling air 204 before the particulates are collected by the second fluid outlet 216.

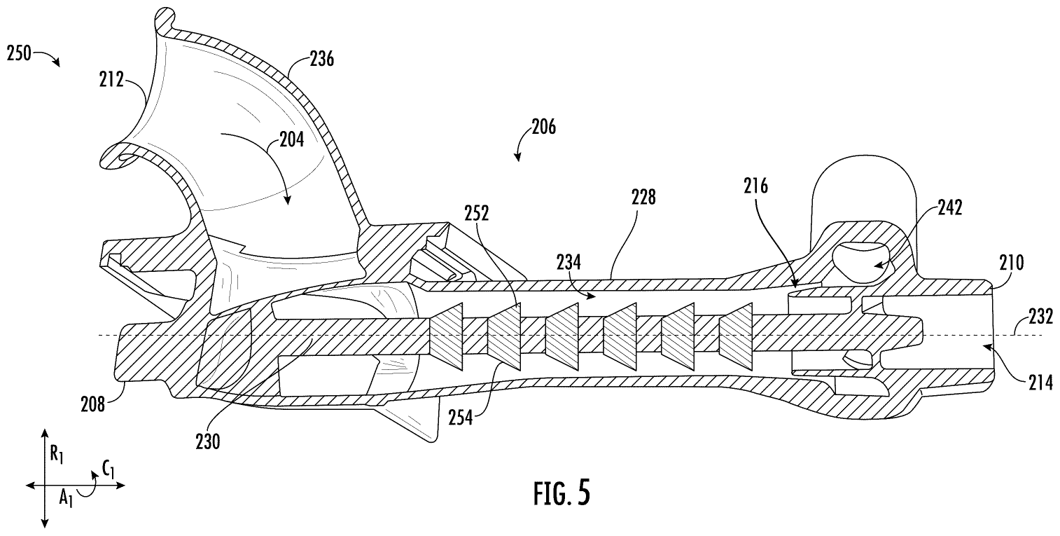

Now referring to FIG. 5, a cross-sectional schematic view of another cyclonic separator 250 is provided. Parts of the cyclonic separator 250 of FIG. 5 that are similar in name or function to parts of the cyclonic separators 202 of FIGS. 3-4C will use similar numerals, and descriptions of such parts as described above apply to those parts in FIG. 5.

The cyclonic separator 250 includes a plurality of fluid deflectors 252, each fluid deflector 252 having an upstream surface 254 with a conical shape. More specifically, the upstream surface 254 of each fluid deflector 252 starts at the central body 230 and extends outward in the radial direction R1 and rearward in the axial direction A1 along a straight diagonal line. The conical shape of the upstream surface 254 may provide additional swirl to the cooling air 204, which may improve movement of the particulates to the outer wall 228. FIG. 5 shows six fluid deflectors 252 arranged as in FIG. 3, and it will be appreciated that the fluid deflectors 252 may be arranged in a different arrangement, such as one of the arrangements of FIGS. 4A-4C.

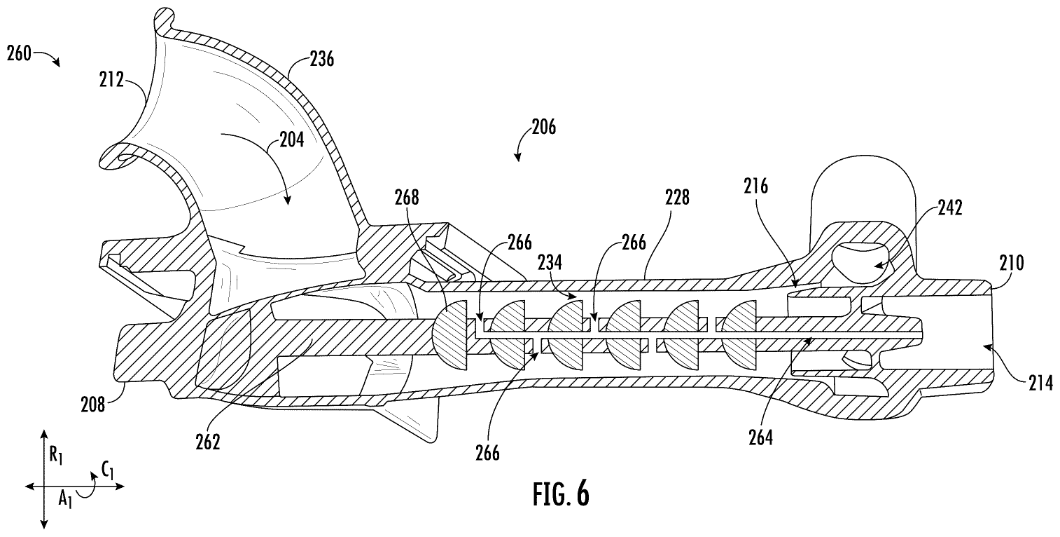

Now referring to FIG. 6, a schematic, cross-sectional view of another exemplary embodiment of a cyclonic separator 260 is shown. Parts of the cyclonic separator 260 of FIG. 6 that are similar in name or function to parts of the cyclonic separators 202, 250 of FIGS. 3-5 will use similar numerals, and descriptions of such parts as described above apply to those parts in FIG. 6.

The cyclonic separator 260 includes a central body 262 defining an annular chamber 234 with a housing 206. The central body 262 defines an internal channel 264 in fluid communication with the first fluid outlet 214 and one or more vents 266 that are in fluid communication with the annular chamber 234. The vents 266 transmit cooling air 204 from the annular chamber 234 the internal channel 264, which transmits the cooling air 204 to the first fluid outlet 214. Because the cooling air 204 closer to the central body 262 has fewer particulates than the cooling air 204 closer to the outer wall 228, the cooling air 204 that is cleaner flows through the internal channel 264 and out to the first fluid outlet 214, bypassing the rest of the cyclonic separator 260.

The cyclonic separator 260 includes one or more fluid deflectors 268 disposed on the central body 262. The fluid deflectors 268 swirl the cooling air 204 in the housing 206, separating particulates away from the central body 262. Some of the cooling air 204 swirled by the fluid deflectors 268 flows into the vents 266 to the internal channel 264.

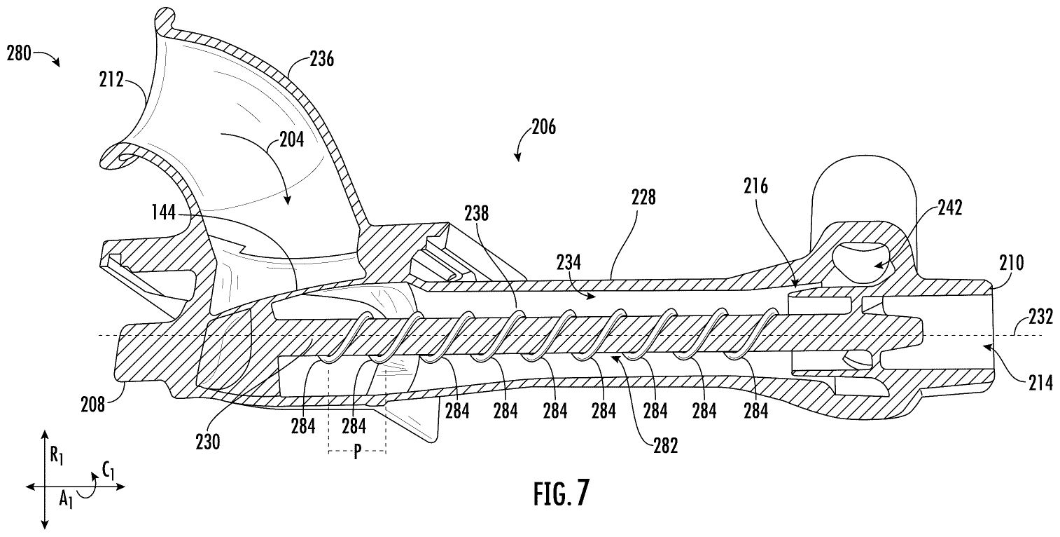

With reference to FIG. 7, a cross-sectional, schematic view of another exemplary embodiment of a cyclonic separator 280 is provided. Parts of the cyclonic separator 280 of FIG. 7 that are similar in name or function to parts of the cyclonic separators 202, 250, 260 of FIGS. 3-6 will use similar numerals, and descriptions of such parts as described above apply to those parts in FIG. 7.

The cyclonic separator 280 includes a central body 230 and a fluid deflector 282 disposed on the central body 230. The fluid deflector 282 directs cooling air 204 from a fluid inlet 212 toward an outer wall 228 to remove particulates through a second fluid outlet 216. The fluid deflector 282 of FIG. 7 is a helical screw extending along an axial direction A1. The helical screw defines a plurality of threads 284 and a thread pitch P. That is, the plurality of threads 284 form a single continuous helical surface extending around and along the helical screw. In this context, the “thread pitch” P is a distance between two consecutive threads 284 of the helical screw. The thread pitch P of the fluid deflector 282 of FIG. 7 is consistent along the axial direction A1 such that the spacing between each adjacent pair of threads 284 is substantially the same.

The fluid deflector 282 is a left-handed helix with a counterclockwise chirality. That is, the fluid deflector 282 curves in a counterclockwise direction moving rearward in the axial direction. The counterclockwise chirality directs the cooling air 204 into a counterclockwise swirl as the cooling air 204 moves in the axial direction A1 toward a first fluid outlet 214.

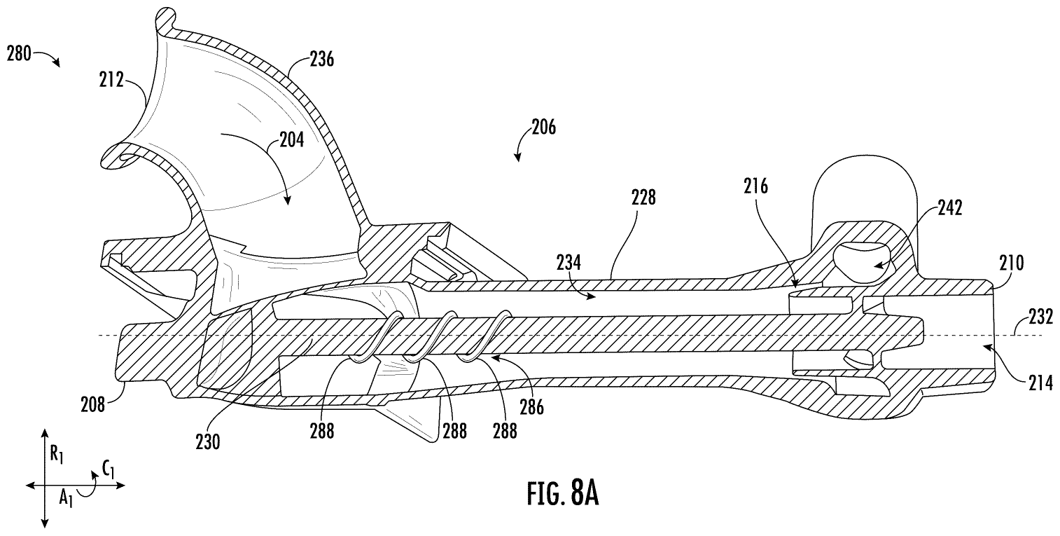

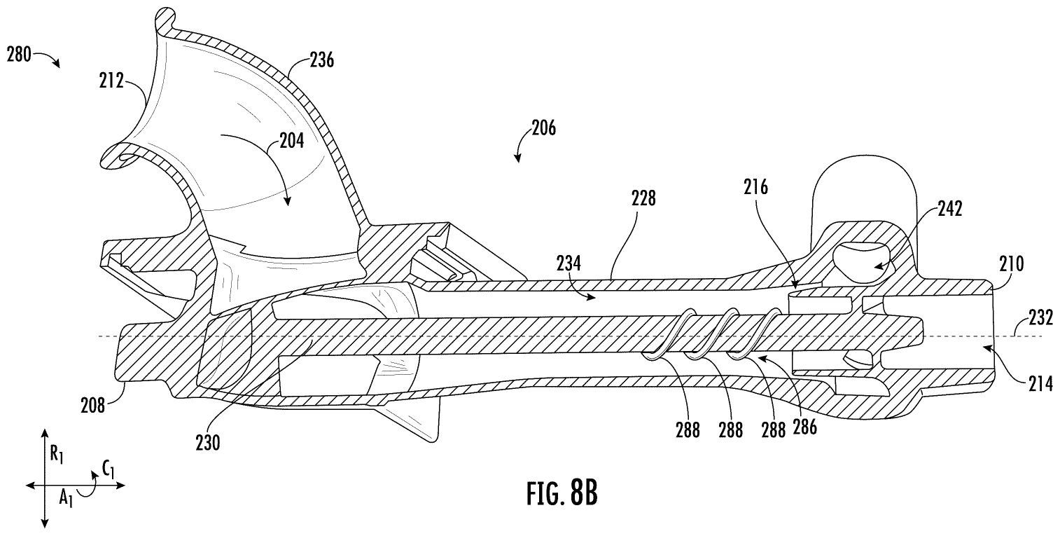

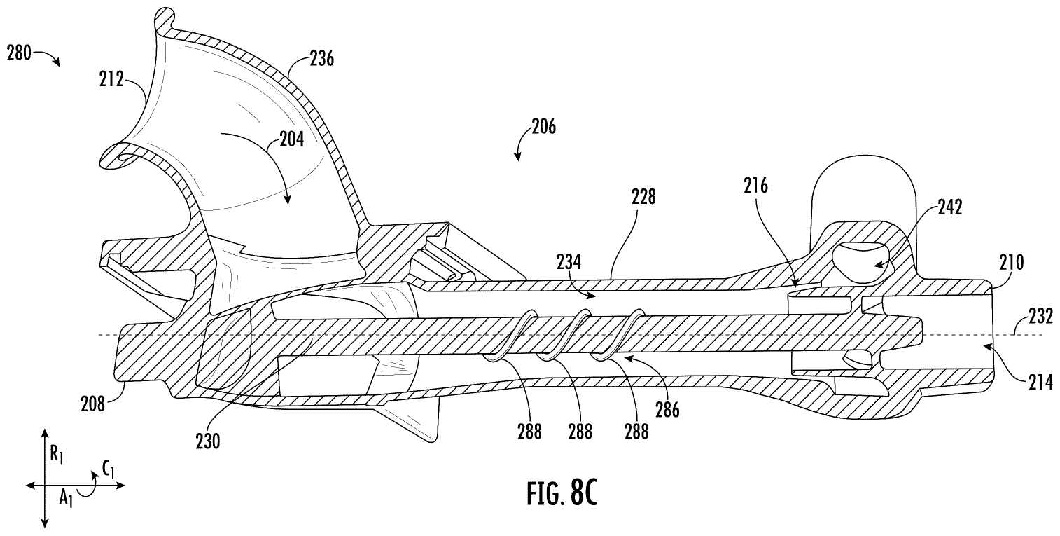

Now referring to FIGS. 8A-8C, cross-sectional schematic views of an exemplary fluid deflector 286 are provided. FIG. 8A shows the fluid deflector 286 arranged at a first axial position proximate to the fluid inlet 212. FIG. 8B shows the fluid deflector 286 arranged at a second axial position proximate to the first fluid outlet 214. FIG. 8C shows the fluid deflector 286 at a third axial position substantially halfway between the fluid inlet 212 and the first fluid outlet 214. In these embodiments, the fluid deflector 286 is a helical screw with a counterclockwise chirality, as with the fluid deflector 282, and has fewer threads 288 than the fluid deflector 282 depicted in FIG. 7.

Still referring to FIGS. 8A-8C, the fluid deflector 286 is positioned on the central body 230 at specified axial positions in the axial direction Al to control where the particulates in the cooling air 204 are directed toward the outer wall 228 and where the fluid deflectors could induce additional swirl to the cooling air 204. As an example, the arrangement of FIG. 8A provides the swirl soon after the cooling air 204 leaves the fluid inlet 212, allowing the cooling air 204 to swirl along the central body 230 toward the first fluid outlet 214 unencumbered.

The arrangement of FIG. 8B provides swirl to the cooling air 204 close to the first fluid outlet 214, increasing the swirl soon before the cooling air 204 leaves the cyclonic separator 280. The particulates may separate directly into the second fluid outlet 216, and thereby are removed from the cyclonic separator 280.

The arrangement of FIG. 8C provides the swirl in the middle of the cyclonic separator 280, which may improve particulate movement toward the outer wall 228 and the second fluid outlet 216. The swirled cooling air 204 may move to the first fluid outlet 214 unencumbered, and the particulates may not have sufficient time to return to the cooling air 204 before the particulates are collected by the second fluid outlet 216.

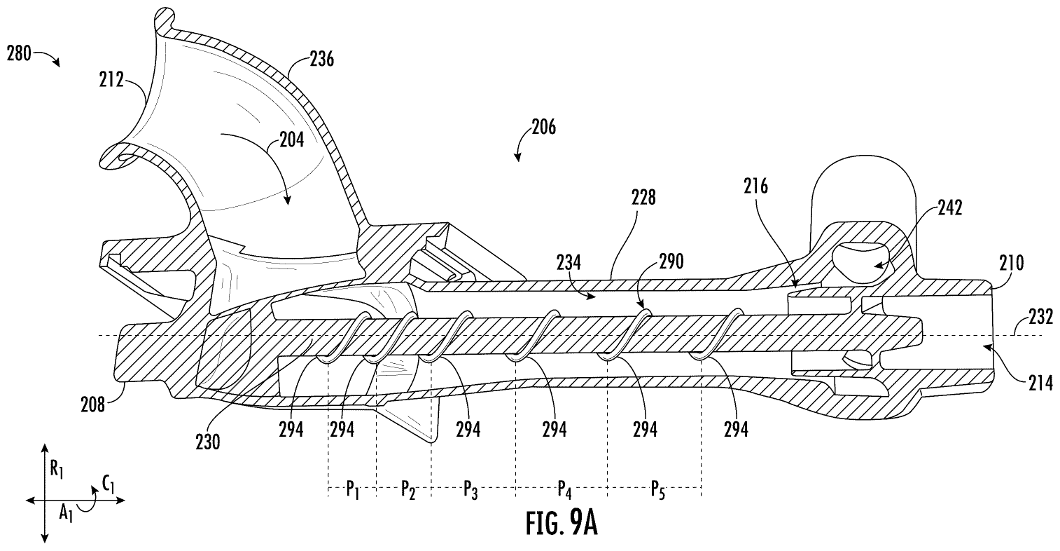

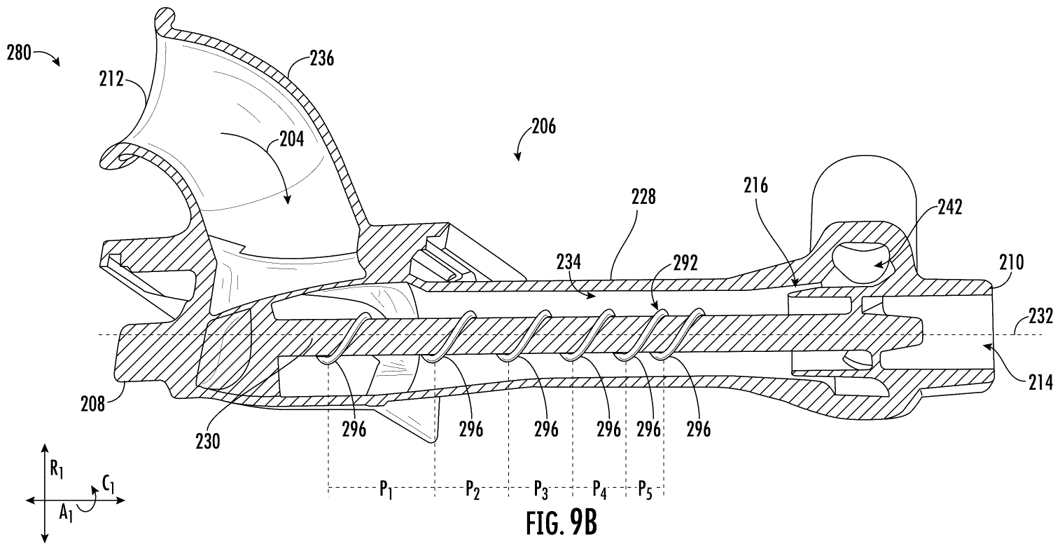

Now referring to FIGS. 9A-9B, cross-sectional schematic views of exemplary fluid deflectors 290, 292 are provided. FIG. 9A shows a fluid deflector 290 with a thread pitch P that increases in the axial direction A1. FIG. 9B shows a fluid deflector 292 with a thread pitch that decreases in the axial direction A1.

By varying the thread pitch of the fluid deflector 290, 292, the cooling air 204 has more or less swirl when moving along the axial direction A1. The change in swirl may improve separation of the particulates from the cooling air 204, particularly when the cooling air 204 approaches the first fluid outlet 214 to leave the cyclonic separator.

In the exemplary embodiment of FIG. 9A, the thread pitch P increase in the axial direction A1, arranging threads 294 farther from each other when moving along the central body 230. The thread pitches P₁, P₂, P₃, P₄, and P₅ are provided to illustrate the increasing thread pitch P, where P₁<P₂<P₃<P₄<P₅. Increasing the thread pitch P from P₁ to P₅ provides less swirl to the cooling air 204 as the cooling air 204 moves through the annular chamber 234, which may allow the cooling air 204 to move unencumbered through the first fluid outlet 214.

Alternatively, in the exemplary embodiment of FIG. 9B, the thread pitch P decreases in the axial direction A1 such that the threads 296 are arranged closer to each other when moving along the central body 230 in the axial direction A1. The thread pitches P₁, P₂, P₃, P₄, and P₅ are provided to illustrate the decreasing thread pitch P, where P₁>P₂>P₃>P₄>P₅. Decreasing the thread pitch P provides less swirl to the cooling air 204 as the cooling air 204 moves through the annular chamber 234, which may cause more particulates to separate from the cooling air 204 closer to the second fluid outlet 216.

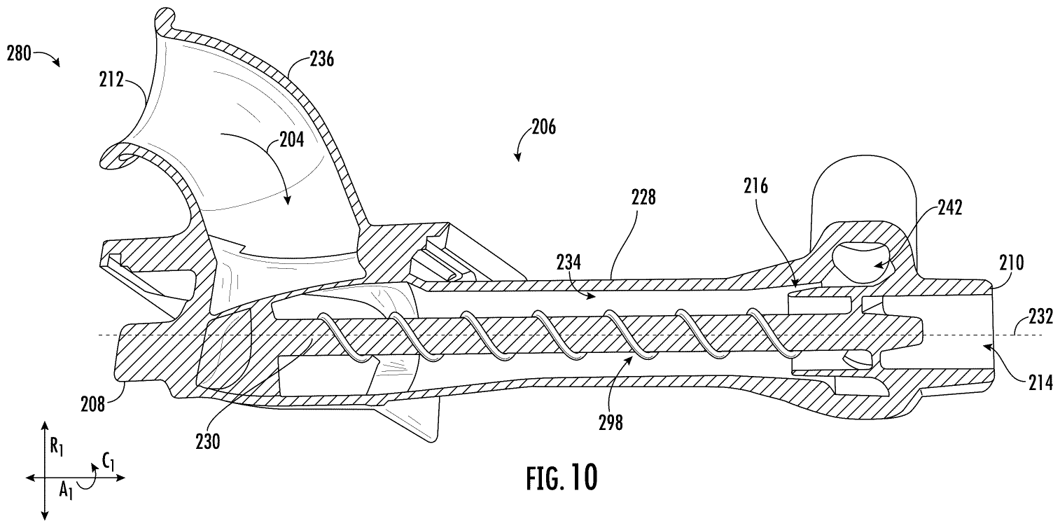

With reference to FIG. 10, a cross-sectional schematic view of an exemplary fluid deflector 298 for a cyclonic separator 280 is provided. The fluid deflector 298 of FIG. 10 is a right-hand helix with a clockwise chirality. The fluid deflector 298 curves in a clockwise direction moving rearward in an axial direction A1. The clockwise chirality directs the cooling air 204 into a clockwise swirl as the cooling air 204 moves in the axial direction A1 toward a first fluid outlet 214. It will be appreciated that the chirality of the fluid deflector 282, 298 may be determined to match the chirality of the swirl that the fluid inlet 212 provides to the cooling air 204. The similar chirality between the fluid inlet 212 and the fluid deflector 282, 298 improves the swirl of the cooling air 204, reducing eddies and other potential turbulence that could mix the particles back into the cooling air 204.

It will be appreciated that any or all the fluid deflectors and the helical screws described above in FIGS. 3-10 may be combined, entirely or in part, for specified fluid flow characteristics in the cyclonic separator.

As disclosed in the FIGS. and described above, the fluid deflectors swirl air in cyclic motion, applying centrifugal force on particulate matter in air flowing through a cyclonic separator. The centrifugal forces push the particulate matter to a radial edge of the cyclonic separator, where an exit flow removes the particulate matter from the cyclonic separator, leaving cleaned air to flow to a fluid outlet. The cleaned air exits the cyclonic separator to cool the components of the gas turbine engine.

Further aspects are provided by the subject matter of the following clauses:

A gas turbine engine includes a compressor section, a turbine section downstream of the compressor section, and a cyclonic separator between the compressor section and the turbine section, the cyclonic separator defining an axial direction and a radial direction, the cyclonic separator including a housing including a first end, a second end, and an outer wall extending between the first end and the second end, a central body disposed in the housing and defining an annular chamber with the outer wall, an inlet disposed at the first end of the housing and in fluid communication with the annular chamber and the compressor section, a first fluid outlet disposed at the second end of the housing and in fluid communication with the turbine section, a second fluid outlet disposed in the outer wall downstream of the first end of the housing, the second fluid outlet extending outward at least partially in the radial direction relative to the outer wall, and a fluid deflector disposed on the central body between the first end of the housing and the second end of the housing, the fluid deflector extending outward in the radial direction and rearward in the axial direction into the annular chamber toward the outer wall.

The gas turbine engine of any of the preceding clauses, wherein the fluid deflector is a helical screw.

The gas turbine engine of any of the preceding clauses, wherein the fluid deflector includes an upstream surface, the upstream surface extending outward in the radial direction and rearward in the axial direction.

The gas turbine engine of any of the preceding clauses, wherein the central body defines an internal channel in fluid communication with the first fluid outlet.

The gas turbine engine of any of the preceding clauses, wherein the turbine section includes a turbine having a cooling passage, and wherein the first fluid outlet disposed at the second end of the housing is fluidly connected to the cooling passage of the turbine.

The gas turbine engine of any of the preceding clauses, further including a cooling circuit fluidly connecting the compressor section to the turbine section, wherein the cooling circuit includes the cyclonic separator.

A cyclonic separator for a turbine cooling airflow of a gas turbine engine, the cyclonic separator defining a centerline, an axial direction, and a radial direction, the cyclonic separator includes a housing including a first end, a second end, and an outer wall extending between the first end and the second end, a central body disposed in the housing along the centerline, the housing defining an annular chamber with the outer wall, an inlet disposed at the first end of the housing and in fluid communication with the annular chamber, a first fluid outlet disposed at the second end of the housing, a second fluid outlet disposed in the outer wall downstream of the first end of the housing, the second fluid outlet extending outward at least partially in the radial direction relative to the outer wall, and a fluid deflector disposed on the central body between the first end of the housing and the second end of the housing, the fluid deflector extending outward in the radial direction and rearward in the axial direction into the annular chamber toward the outer wall.

The cyclonic separator of any of the preceding clauses, wherein the fluid deflector is a helical screw.

The cyclonic separator of any of the preceding clauses, wherein the helical screw defines a plurality of threads and a thread pitch between the plurality of threads.

The cyclonic separator of any of the preceding clauses, wherein the thread pitch is consistent along the axial direction.

The cyclonic separator of any of the preceding clauses, wherein the thread pitch varies along the axial direction.

The cyclonic separator of any of the preceding clauses, wherein the fluid deflector includes an upstream surface, the upstream surface extending outward in the radial direction and rearward in the axial direction.

The cyclonic separator of any of the preceding clauses, wherein the upstream surface has a hemispherical shape.

The cyclonic separator of any of the preceding clauses, wherein the upstream surface has a conical shape.

The cyclonic separator of any of the preceding clauses, wherein the central body defines an internal channel in fluid communication with the first fluid outlet.

The cyclonic separator of any of the preceding clauses, wherein the central body defines a vent in fluid communication with the internal channel.

The cyclonic separator of any of the preceding clauses, wherein the inlet has a bend arranged to swirl air around the central body.

The cyclonic separator of any of the preceding clauses, wherein the fluid deflector extends toward the second fluid outlet.

The cyclonic separator of any of the preceding clauses, wherein the second fluid outlet defines an outlet passage in fluid communication with an exit flow.

The cyclonic separator of any of the preceding clauses, wherein the fluid deflector is arranged to direct air moving in the axial direction outward in the radial direction toward the second fluid outlet.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine engine comprising:
a compressor section;
a turbine section downstream of the compressor section; and
a cyclonic separator disposed between the compressor section and the turbine section, the cyclonic separator defining an axial direction and a radial direction, the cyclonic separator comprising:
a housing comprising a first end, a second end, and an outer wall extending between the first end and the second end;
a central body disposed in the housing and defining an annular chamber with the outer wall;
an inlet disposed at the first end of the housing and in fluid communication with the annular chamber and the compressor section;
a first fluid outlet disposed at the second end of the housing and in fluid communication with the turbine section;
a second fluid outlet disposed in the outer wall downstream of the first end of the housing, the second fluid outlet extending outward at least partially in the radial direction relative to the outer wall; and
a fluid deflector disposed on the central body between the first end of the housing and the second end of the housing, the fluid deflector extending outward in the radial direction and rearward in the axial direction into the annular chamber toward the outer wall.

2. The gas turbine engine of claim 1, wherein the fluid deflector is a helical screw.

3. The gas turbine engine of claim 1, wherein the fluid deflector includes an upstream surface, the upstream surface extending outward in the radial direction and rearward in the axial direction.

4. The gas turbine engine of claim 1, wherein the central body defines an internal channel in fluid communication with the first fluid outlet.

5. The gas turbine engine of claim 1, wherein the turbine section comprises a turbine having a cooling passage, and wherein the first fluid outlet disposed at the second end of the housing is fluidly connected to the cooling passage of the turbine.

6. The gas turbine engine of claim 1, further comprising a cooling circuit fluidly connecting the compressor section to the turbine section, wherein the cooling circuit comprises the cyclonic separator.

7. A cyclonic separator for a turbine cooling airflow of a gas turbine engine, the cyclonic separator defining a centerline, an axial direction, and a radial direction, the cyclonic separator comprising:
a housing comprising a first end, a second end, and an outer wall extending between the first end and the second end;
a central body disposed in the housing along the centerline, the housing defining an annular chamber with the outer wall;
an inlet disposed at the first end of the housing and in fluid communication with the annular chamber;
a first fluid outlet disposed at the second end of the housing;
a second fluid outlet disposed in the outer wall downstream of the first end of the housing, the second fluid outlet extending outward at least partially in the radial direction relative to the outer wall; and
a fluid deflector disposed on the central body between the first end of the housing and the second end of the housing, the fluid deflector extending outward in the radial direction and rearward in the axial direction into the annular chamber toward the outer wall.

8. The cyclonic separator of claim 7, wherein the fluid deflector is a helical screw.

9. The cyclonic separator of claim 8, wherein the helical screw defines a plurality of threads and a thread pitch between the plurality of threads.

10. The cyclonic separator of claim 9, wherein the thread pitch is consistent along the axial direction.

11. The cyclonic separator of claim 9, wherein the thread pitch varies along the axial direction.

12. The cyclonic separator of claim 7, wherein the fluid deflector includes an upstream surface, the upstream surface extending outward in the radial direction and rearward in the axial direction.

13. The cyclonic separator of claim 12, wherein the upstream surface has a hemispherical shape.

14. The cyclonic separator of claim 12, wherein the upstream surface has a conical shape.

15. The cyclonic separator of claim 7, wherein the central body defines an internal channel in fluid communication with the first fluid outlet.

16. The cyclonic separator of claim 15, wherein the central body defines a vent in fluid communication with the internal channel.

17. The cyclonic separator of claim 7, wherein the inlet has a bend arranged to swirl air around the central body.

18. The cyclonic separator of claim 7, wherein the fluid deflector extends toward the second fluid outlet.

19. The cyclonic separator of claim 7, wherein the second fluid outlet defines an outlet passage in fluid communication with an exit flow.

20. The cyclonic separator of claim 7. wherein the fluid deflector is arranged to direct air moving in the axial direction outward in the radial direction toward the second fluid outlet.
